(19) United States
(12) Patent Application Publication
(10) Pub. No.: US 2017/0287441 A1
(43) Pub. Date: Oct. 5, 2017

(54) METHOD AND SYSTEM FOR PERIPHERAL VISUAL ALERT SYSTEM

(71) Applicant: FASTMOTO, LLC, Redwood City, CA (US)

(72) Inventor: Ain MCKENDRICK, Redwood City, CA (US)

(73) Assignee: FASTMOTO, LLC, Redwood City, CA (US)

(21) Appl. No.: 15/473,373

(22) Filed: Mar. 29, 2017

Related U.S. Application Data
(60) Provisional application No. 62/314,877, filed on Mar. 29, 2016.

(51) Int. Cl. G09G 5/36; G06F 3/147; G08B 5/36; G06F 1/16

(52) U.S. Cl. CPC G09G 5/363; G06F 1/163; G06F 3/147; G08B 5/36; G09G 2370/06; G09G 2320/10

(57) ABSTRACT

An apparatus may include a protective shell to protect a head of a wearer of the apparatus, where the protective shell may include a void of material positioned to be proximate a face of the wearer of the apparatus when wearing the apparatus. The apparatus may additionally include a visual interface device located proximate a border of the protective shell and the void of material, and a controller to provide display signals to the visual interface device.

### CROSS-REFERENCE TO RELATED APPLICATIONS

This application claims the benefit of U.S. Provisional Patent Application No. 62/314,877, filed Mar. 29, 2016, which is incorporated herein by reference in its entirety.

### FIELD

The embodiments of the present disclosure are related to the field of visual display systems associated with a wearable helmet or goggles. Some embodiments of the present disclosure relate to a method and system for supporting visual notifications and alerts to a helmet or goggle wearer that can be driven by electronic sensors or computing devices via a wired or wireless connection to the helmet or goggles.

### BACKGROUND

Peripheral vision is a part of vision that occurs outside the very center of gaze. There is a broad set of non-central points in the visual field that is included in the notion of peripheral vision. “Far peripheral” vision refers to the area at the edges of the visual field, “mid-peripheral” vision exists in the middle of the visual field, and “near-peripheral,” sometimes referred to as “para-central” vision, exists adjacent to the center of gaze.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

One or more embodiments of the present disclosure may include an apparatus that includes a protective shell to protect a head of a wearer of the apparatus, where the protective shell may include a void of material positioned to be proximate a face of the wearer of the apparatus when wearing the apparatus. The apparatus may additionally include a visual interface device located proximate a border of the protective shell and the void of material, and a controller to provide display signals to the visual interface device.

One or more embodiments of the present disclosure may include an apparatus that includes a covering to cover eyes of a wearer of the apparatus, and a visual interface device including multiple light emitting elements in a group, where the visual interface device may be located proximate a border of the covering. The apparatus may also include a controller to provide display signals to the visual interface device.

One or more embodiments of the present disclosure may include a method that includes receiving, at a controller on a wearable apparatus, a request to display a visual alert on a visual interface device of the wearable apparatus, the visual interface device located at one of a chin guard or a visor of the wearable apparatus. The method may also include displaying the visual alert on the visual interface device.

The object and advantages of the embodiments will be realized and achieved at least by the elements, features, and combinations particularly pointed out in the claims.

It is to be understood that both the foregoing general description and the following detailed description are merely examples and explanatory and are not restrictive of the claims.

### BRIEF DESCRIPTION OF THE DRAWINGS

Example embodiments will be described and explained with additional specificity and detail through the use of the accompanying drawings in which:

FIG. 1 illustrates one example apparatus with a peripheral visual display;

FIGS. 2A and 2B illustrate other example apparatuses with a peripheral visual display;

FIG. 3 illustrates a system for wireless transmission of visual information to a peripheral visual display;

FIG. 4 illustrates example visual patterns that may be displayed by the peripheral visual display system;

FIG. 5 illustrates a flowchart of an example method of triggering a visual alert; and

FIG. 6 is a block diagram illustrating a device to facilitate display on a peripheral visual display.

### DESCRIPTION OF EMBODIMENTS

Some embodiments of the present disclosure include a method and system for illuminating a visual interaction device (e.g., a lighting system) within the peripheral vision of a helmet or goggle wearer. Some embodiments provide for a method and system of dynamically setting a sequence of colors, patterns, and/or pulsations to provide unique visual cues to the wearer. Some embodiments include a controller (such as one or more processors) that can be connected to electronic sensors within a helmet or goggle to receive trigger events from the sensors that trigger visual alerts, and in turn provide signals to the visual interaction device to display the visual alert. Some embodiments provide an electronic control system that can be connected wirelessly to other devices to provide visual information to the helmet or goggle wearer.

In some embodiments, the electronic control system for the peripheral visual display may provide both pre-programmed visual indications and/or dynamic visual indications based on transmitted information from an electronic device or computer. In some embodiments, the electronic control system for the peripheral visual display may receive data to display from a mobile phone application or another device through a wired or wireless data connection.

Safety helmets and goggles used for motorcycles, bicycles, and sports in general are not typically enabled with electronic displays for providing information to the wearer. Some products have been proposed that involve adding a small visual display to a helmet or goggle which partially obscures the wearer's field of view. While these systems do provide information, the risk to the wearer of partially obscuring their vision is a major concern. However, in conjunction with one or more embodiments of the present disclosure, peripheral vision may be used. Peripheral vision is weak in humans at distinguishing detail and shape, but can be used for triggering alerts or notifications with movement, and light.

### Mounting of Peripheral Visual Display

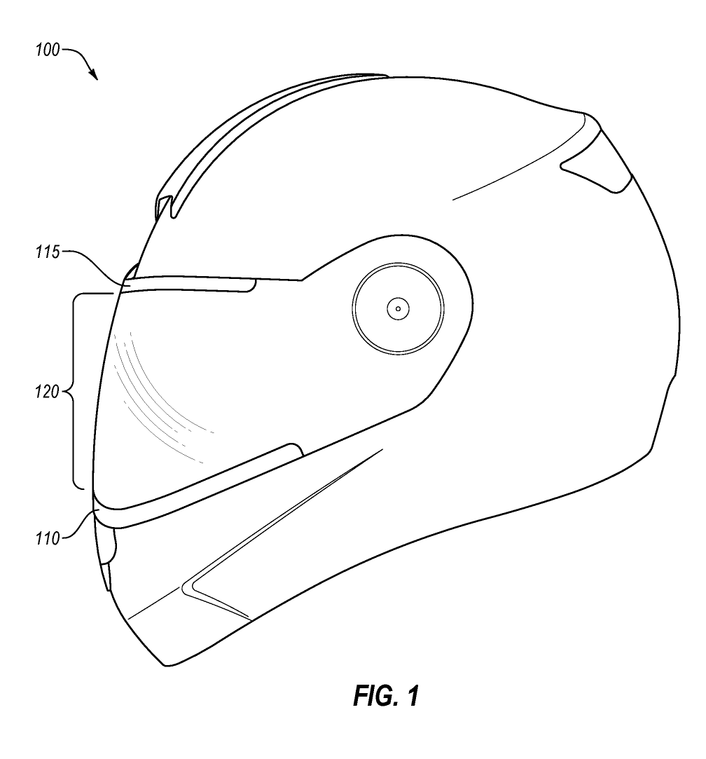

FIG. 1 illustrates one example apparatus 100 with a peripheral visual display 110, in accordance with one or more embodiments of the present disclosure. The apparatus 100 may include a visual interface device that may include a first visual display 110 coupled to the apparatus 100 proximate a chin guard of the apparatus 100 and a second visual display 115 proximate a visor of the apparatus 100.

The apparatus 100 may be implemented as a motorcycle helmet, bicycle helmet, ski helmet, or any other protective head gear. The apparatus 100 may include a protective shell configured to protect a head of a wearer of the apparatus 100. For example, the apparatus 100 may include a material configured to absorb or redirect a force from a crash or other impact to protect the head of the wearer of the apparatus 100. The apparatus 100 may include a void 120 in material proximate a face of the wearer. The void 120 may serve as a region through which a wearer of the apparatus 100 may observe or otherwise see what is going on around the wearer of the apparatus 100. The void 120 may or may not be covered with a covering for the eyes and/or face of the wearer of the apparatus 100.

In some embodiments, the void 120 may encompass all or a portion of a main field of view of the wearer of the apparatus 100 as well as at least a portion of a region peripheral to the main field of view. As used in the present disclosure, the main field of view may include a direct line of sight when the eyes of the wearer of the apparatus are centered in the eye sockets (e.g., looking directly ahead) and approximately thirty degrees of rotation in any direction off of the centered position in the eye socket. A region described as peripheral to the main field of view may include any region outside of the main field of view and within one hundred and ten degrees of rotation in any direction off of the centered position in the eye socket. Stated another way, the main field of view may include the primary line of sight in the direction of view from an apparatus (such as the direction of the void 120 or the direction of a visor or a direction of travel when wearing the apparatus), and the region described as peripheral to the main field of view may include any region viewable in peripheral vision when looking at the main field of view. Furthermore, the peripheral region may be further understood by reference to the examples of the present disclosure.

In some embodiments, the first visual display 110 may be coupled to a chin guard of the apparatus 100 such that the first visual display 110 is in the bottom peripheral vision of the wearer of the apparatus 100. Additionally or alternatively, the second visual display 115 may be coupled to a visor of the apparatus 100, such that the second visual display 110 is in the top peripheral vision of the wearer of the apparatus 100. For example, as the wearer of the apparatus 100 looks directly ahead (the main field of view), both the first visual display 110 and the second visual display 115 may be in the region peripheral to the main field of view. By placing the first and/or second visual display devices 110/115 in the region peripheral to the main field of view, the wearer of the apparatus 100 may have their main field of view unobstructed, but may receive visual indications via the first and/or second visual display devices 110/115 in their peripheral vision.

In some embodiments, the first visual display 110 and the second visual display 115 may be independently controllable such that any combination of visual cues may be given to the first visual display 110, the second visual display 115, or any combination thereof.

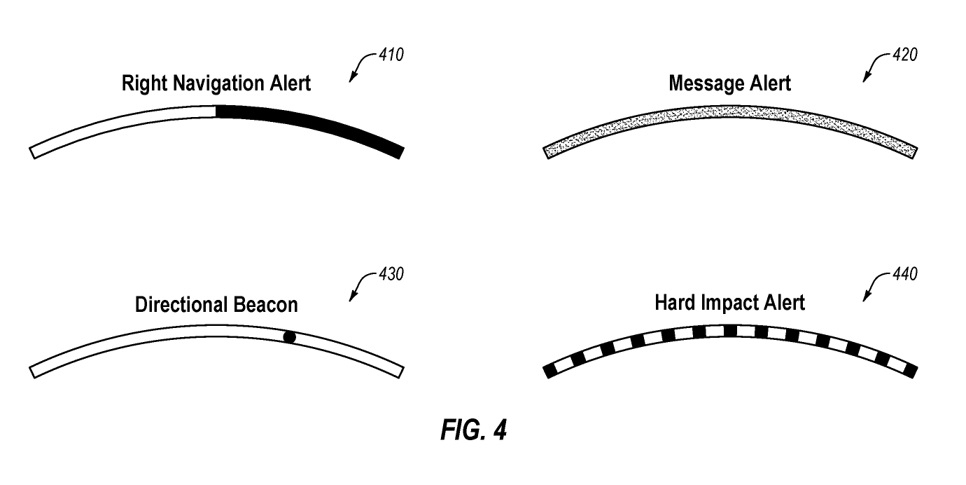

The visual interface device (e.g., the first visual display 110 and/or the second visual display 115) may include any light emitting element, such as a light emitting diode (LED), a resistive light bulb, a fluorescent light bulb, a light emitting element with a selective filter, or any combinations thereof. In some embodiments, the first visual display 110 and/or the second visual display may include multiple light emitting elements in a group or row, such as in a light strip, an LED strip, and/or others. The first visual display 110 and/or the second visual display may be configured to emit light in different colors (e.g., by including multiple light emitting elements with different colors (such as red, green, blue) and adjusting the output of the different colors, etc.). Additionally or alternatively, the first visual display 110 and/or the second visual display may be configured to turn on or off various portions of the group of light emitting elements in different patterns (some examples of which are illustrated in FIG. 4). In some embodiments, a controller may provide signals to the visual interface device regarding what color, what portions, what duration, etc. of the visual interface device is to be used for a visual notification or alert.

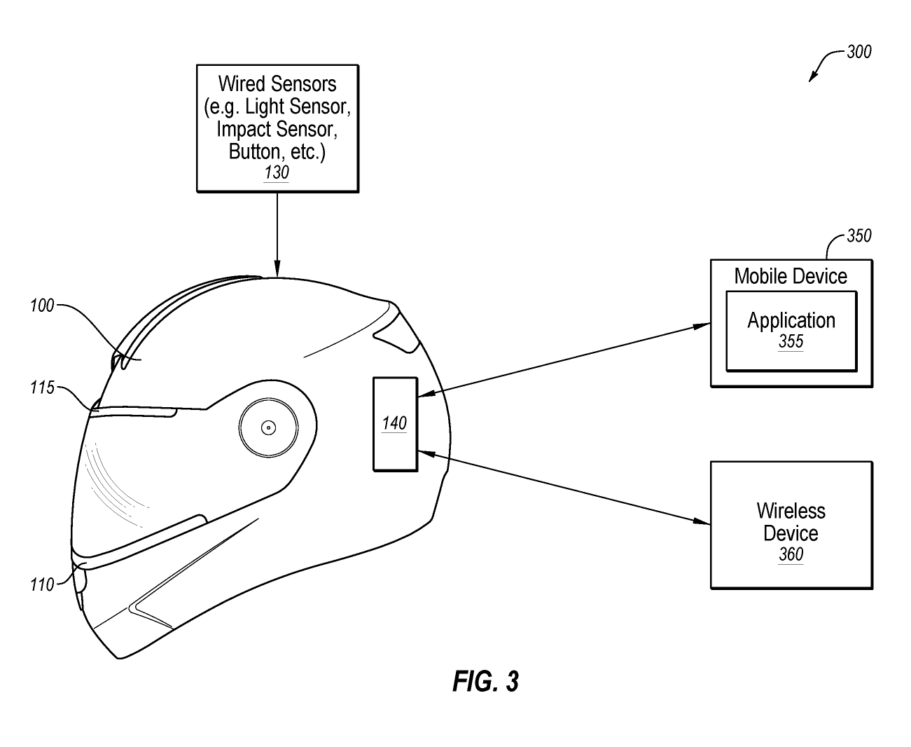

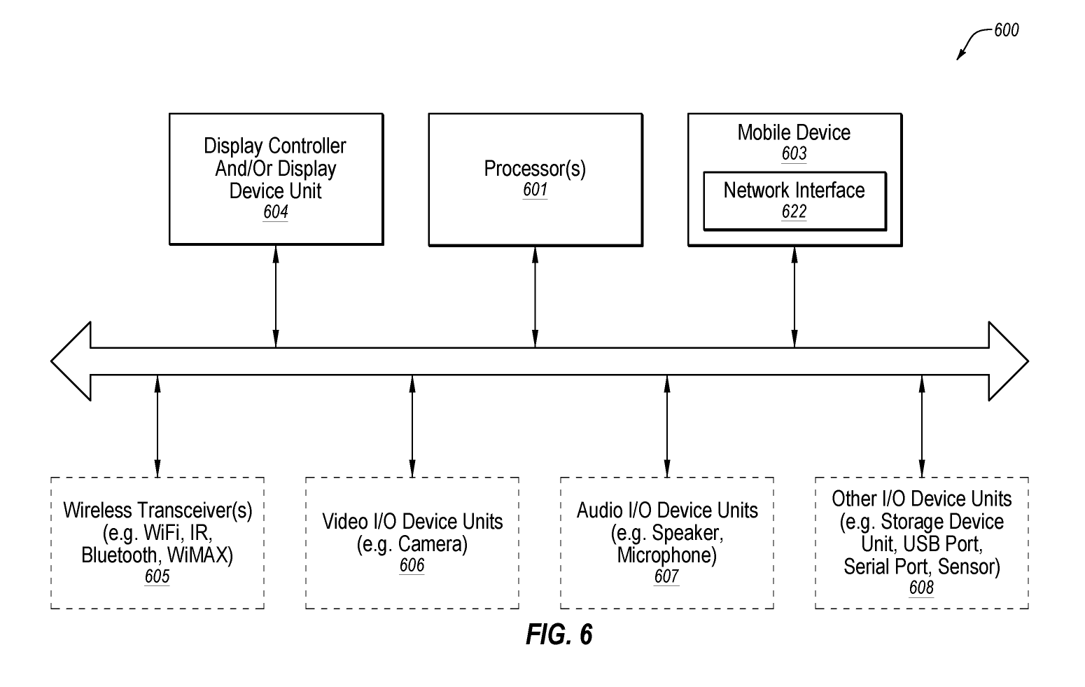

Modifications, additions, or omissions may be made to the apparatus 100 without departing from the scope of the present disclosure. For example, the apparatus 100 may include any number of peripheral visual displays, such in the top peripheral view, bottom peripheral view, left peripheral view, and right peripheral view. As another example, the apparatus 100 may include one or more of the components illustrated and/or discussed with reference to FIGS. 3 and 6.

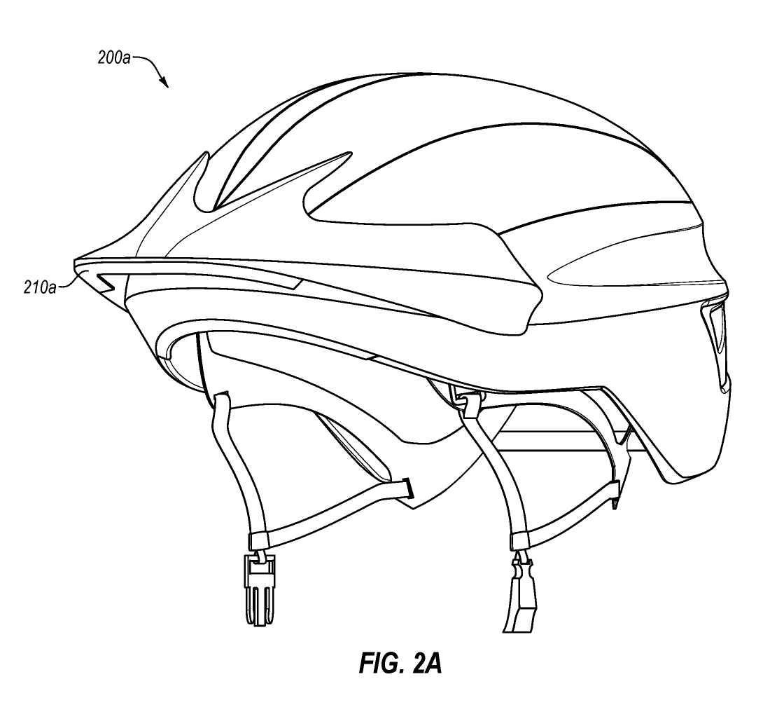

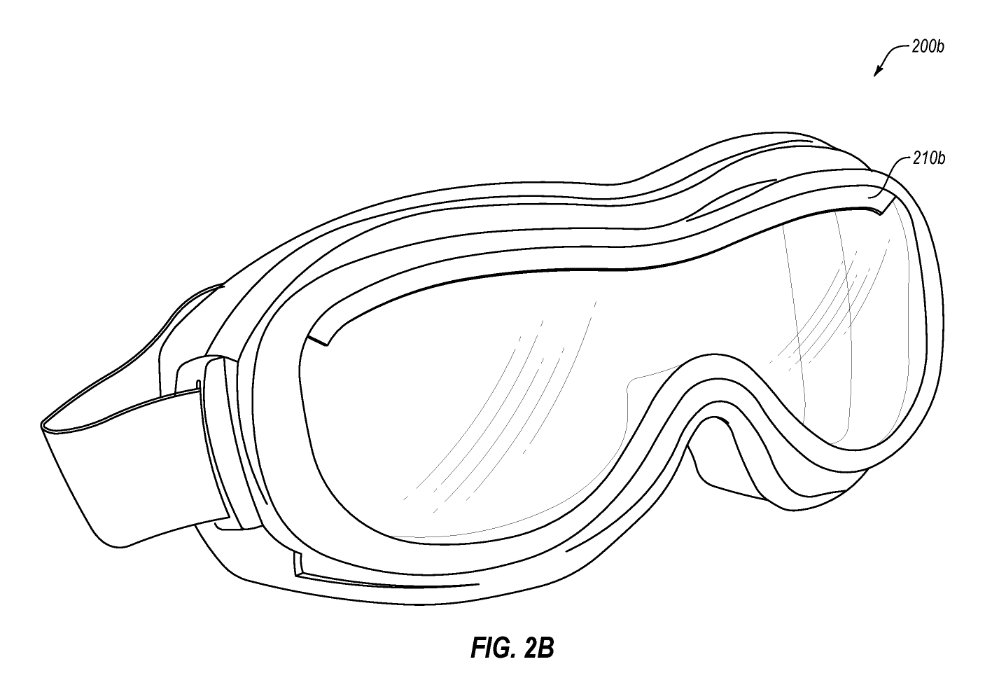

FIGS. 2A and 2B illustrate other example apparatuses 200a and 200b, respectively, with a peripheral visual display, in accordance with one or more embodiments of the present disclosure. For example, FIG. 2A illustrates an example embodiment of the apparatus 200a that may be implemented as a bicycle helmet and FIG. 2B illustrated an example embodiment of the apparatus 200b that may be implemented as goggles.

The apparatuses 200a and 200b may be similar or comparable to the apparatus 100 of FIG. 1. Additionally or alternatively, the visual interface devices 210a and 210b may be similar or comparable to the visual displays 110 and 115 of FIG. 1.

As illustrated in FIG. 2A, the visual interface device 210a may be coupled to a sun visor of the apparatus 200a. As illustrated in FIG. 2B, the visual interface device 210b may be coupled to a border or edge of the apparatus 200b.

Modifications, additions, or omissions may be made to the apparatuses 200a and/or 200b without departing from the scope of the present disclosure. For example, the apparatus 200a and/or 200b may include any number of peripheral visual displays. For example, the apparatus 200b may include a visual display along the top and/or the bottom of the apparatus 200b.

### Linkage to Sensors or Applications

FIG. 3 illustrates a system 300 for wireless transmission of visual information to a peripheral visual display, in accordance with one or more embodiments of the present disclosure. The system 300 may include the apparatus 100 of FIG. 1.

The apparatus 100 may include one or more wired sensors 130 and a wireless link 140. The one or more wired sensors may provide a trigger to cause a display of a visual alert on one or more of the visual displays 110/115. For example, one of the wired sensors 130 may send an electronic signal as a trigger to a controller. The controller may associate the trigger with a particular alert and provide a signal to the visual displays 110 and/or 115 to display a visual alert associated with the particular alert.

The wired sensors 130 may include a light sensor (e.g., to detect headlights of a vehicle), an impact sensor (e.g., to detect when a crash has occurred), a gyroscope and/or accelerometer (e.g., to detect how the apparatus 100 is moving, a direction the apparatus 100 is facing, etc.), magnetometer, compass, and/or others.

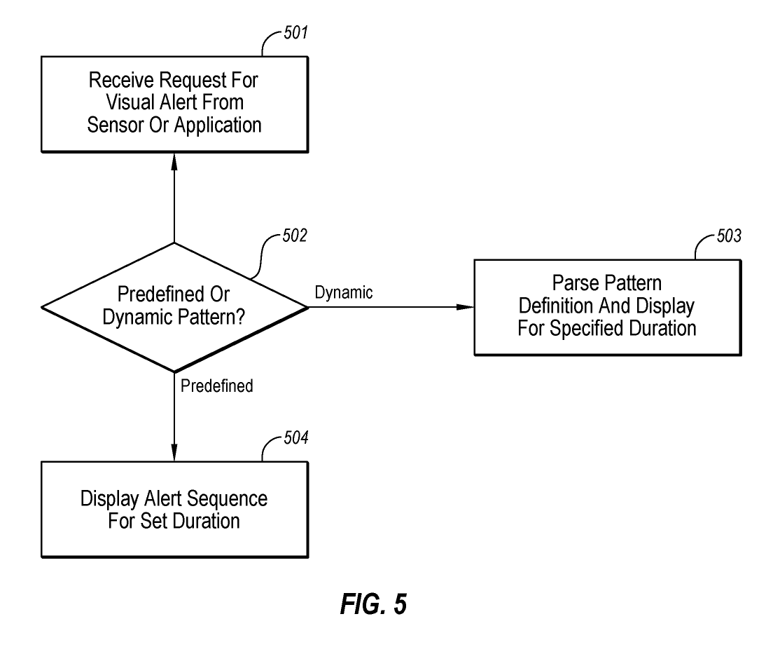

The wireless link 140 may function as a communication device to configure the apparatus 100 to be communicatively coupled using wireless communication to one or more other devices, such as a mobile device 350 and/or a wireless device 360. As described with respect to FIGS. 5 and 6, the mobile device 350 and/or the wireless device 360 may provide a static or a dynamic visual alert to the apparatus 100 to be displayed on the visual interface device. For example, an application (app) 355 running on the mobile device 350 may provide turn-by-turn directions to a user of the application 355. As the wearer of the apparatus 100 approaches a next turn, the application 355 may cause the mobile device 350 to transmit a wireless signal over the wireless link 140 to a controller of the apparatus 100 to provide a visual alert on the visual interface device of the direction of the upcoming turn.

Modifications, additions, or omissions may be made to the system 300 without departing from the scope of the present disclosure. For example, the system 300 may include any number of wired and/or wireless sensors or devices communicatively coupled to the apparatus 100 such that any of the wired and/or wireless sensors or devices may provide a trigger or an alert associated with a visual alert, or may provide directions for a dynamic visual alert. As another example, the system 300 may include one or more of the components illustrated and/or discussed with reference to FIG. 6.

### Example Patterns for Peripheral Visual Alerts

FIG. 4 illustrates example visual patterns that may be displayed by the peripheral visual display system, in accordance with one or more embodiments of the present disclosure. For example, the visual pattern 410 may include a right navigation alert by illuminating a right-side of a visual interaction device. In some embodiments, the visual pattern 410 may be displayed in a color such as green that may be associated with navigation directions. Additionally or alternatively, the visual indication may intermittently blink similar to a turn signal.

The visual pattern 420 may include a message alert. For example, the visual pattern 420 may indicate that a mobile device of the wearer has received a text message, an e-mail, or some other electronic message. The visual pattern 420 may highlight a full length of the visual interaction device in a light blue for a short duration.

The visual pattern 430 may include a directional beacon. For example, the directional beacon may include one point in the visual interaction device that may illuminate in a particular direction, such as north. As another example, the directional beacon may be based on an application on a mobile device indicating where a friend or other contact is located. As an additional example, the directional beacon may be based on which lane a user should be traveling in for a next set of directions.

The visual pattern 440 may include a hard impact alert. The visual pattern 440 may include a staggered illumination in a warning color such as red or yellow. Additionally or alternatively, the visual pattern 440 may be flashing. Such a hard impact alert may be generated when one or more sensors detect one or more indicators of a hard impact (e.g., a rapidly approaching vehicle, a gyroscope indicating a bicycle/motorcycle is past a tipping point, a rapid decrease in velocity, etc.)

The visual patterns illustrated in FIG. 4 are merely illustrative and it will be appreciated that any combination of colors, patterns, durations, portions illuminated, etc. may be used for any number or combination of visual alerts. Furthermore, the present disclosure includes embodiments of both predefined, stored visual patterns as well as dynamic (e.g., new and not previously encountered or not stored) visual patterns that may be displayed on a visual interaction device.

### Pre-Defined or Dynamic Alert Patterns

FIG. 5 illustrates a flowchart of an example method 500 of triggering a visual alert, in accordance with one or more embodiments of the present disclosure.

At block 501, a request may be received to display a visual alert. For example, a sensor may send a signal of a trigger event to a controller associated with a visual interaction device. As an additional example, a mobile device or other wireless device may transmit a signal to the controller requesting that a visual alert be displayed.

At block 502, a determination may be made whether the request is to display a predefined alert pattern and duration, or if the request contains data for a dynamic alert pattern. For example, the controller may determine whether the request is associated with a stored visual alert with an associated visual pattern. For example, a stored visual pattern may include one or more light emitting elements or groups thereof that are illuminated, a duration of the illumination, a color of the illumination, etc. In some embodiments, the stored visual patterns may each be unique such that a user may identify and/or otherwise associate a given visual pattern with the associated alert, for example, as described in FIG. 4. If the request is for a dynamic alert, the method 500 may proceed to block 503. If the request is for a predefined alert, the method 500 may proceed to block 504.

At block 503, a pattern definition may be parsed. For example, for a dynamic request, the request may include a pattern definition of what visual pattern to display. In some embodiments, the pattern definition may include elements such as pattern, color, and duration. The pattern definition may be parsed to determine the various aspects of the visual pattern. The visual pattern may be displayed on the visual interaction device.

At block 504, the predefined alert pattern may be displayed on the visual interaction device. For example, at block 502, if a particular visual pattern is identified as associated with the request, the particular visual pattern may be displayed.

Modifications, additions, or omissions may be made to the method 500 without departing from the scope of the present disclosure. For example, the operations of the method 500 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the present disclosure.

### Electronic Devices Implementing a Peripheral Visual Display

FIG. 6 is a block diagram illustrating a device 600 to facilitate display on a peripheral visual display, in accordance with one or more embodiments of the present disclosure. The device 600 may represent a device performing any of the processes or methods described above. For example, the device 600 may receive trigger events or other indications to display a visual alert on a visual interaction device. The device 600 may include many different components. These components can be implemented as integrated circuits (ICs), portions thereof, discrete electronic devices, or other modules adapted to a circuit board such as a motherboard or add-in card of a computing system, or as components otherwise incorporated within a chassis of the computing system. Note also that the device 600 is intended to show a high level view of many components. However, it is to be understood that additional components may be present in certain implementations and furthermore, different arrangement of the components shown may occur in other implementations.

In one embodiment, the device 600 includes one or more processors 601, memory 603, and device units 605-1208 that are interconnected via a bus or an interconnect 1210.

The one or more processors 601 may represent a single processor or multiple processors with a single processor core or multiple processor cores included therein. The one or more processors 601 may represent one or more general-purpose processors such as a microprocessor, a central processing unit (CPU), or processing device. More particularly, the one or more processors 601 may include a complex instruction set computing (CISC) microprocessor, reduced instruction set computing (RISC) microprocessor, very long instruction word (VLIW) microprocessor, or processor implementing other instruction sets, or processors implementing a combination of instruction sets. The one or more processors 601 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

The one or more processors 601, which may be a low power multi-core processor socket such as an ultra low voltage processor, may act as a main processing unit and central hub for communication with the various components of the system. Such a processor can be implemented as a system on chip (SoC). The one or more processors 601 may be configured to execute instructions for performing the operations and steps discussed herein.

The device 600 may include a display subsystem 604, which may include a display controller and/or a visual interaction device such as one or more visual displays. The visual displays may be implemented, for example, as LED arrays or light strips. In some embodiments, the display controller may be implemented as part of the one or more processors 601. The display controller may be configured to receive signals related to a visual alert and generate signals to the one or more visual interaction devices to display a visual pattern of the visual alert. For example, the display controller may receive a signal regarding a triggering event, may find a visual alert associated with the triggering event, and sending signals to display a visual pattern of the visual alert.

The one or more processor 601 may communicate with memory 603, which in an embodiment can be implemented via multiple memory devices to provide for a given amount of system memory. The memory device can be any type of dynamic, static or similar random access storage devices. As examples, any amount of storage may be present in the device 600, e.g., 8/6/32 megabytes (MB) or gigabytes (GB) of system memory may be present and can be coupled to the one or more processor 601 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

In some embodiments, the memory 603 may store one or more predefined visual patterns associated with a given visual alert and/or trigger event. For example, a sensor may send a signal to the one or more processors 601 of a triggering event and the processor may identify a stored visual alert and visual pattern associated with the trigger event stored in the memory 603.

The memory 603 may include one or more volatile storage (or memory) devices such as random access memory (RAM), dynamic RAM (DRAM), synchronous DRAM (SDRAM), static RAM (SRAM), or other types of storage devices. The memory 603 may store information including sequences of instructions that are executed by the one or more processor 601, or any other device units. For example, executable code and/or data of a variety of operations and/or applications can be loaded in the memory 603 and executed by the one or more processors 601. Applications may include any type of program, including operating systems such as, for example, Linux®, Unix®, or other real-time or embedded operating systems such as VxWorks.

The device 600 may further include input/output (I/O) devices such as the device units 605-608, including wireless transceiver(s) 605, video I/O device unit(s) 606, audio I/O device unit(s) 607, and other I/O device units 608. The wireless transceiver 605 may be a WiFi transceiver, an infrared transceiver, a Bluetooth transceiver, a WiMax transceiver, a wireless cellular telephony transceiver, a satellite transceiver (e.g., a global positioning system (GPS) transceiver), a near-field communication (NFC) transceiver, or other radio frequency (RF) transceivers, or a combination thereof. The wireless transceiver 605 may be configured to receive a request to display a visual alert, for example, from a mobile device communicatively coupled to the device 600 via the wireless transceiver 605. The wireless transceiver 605 may operate as a communication device such that the device 600 may be communicatively coupled with one or more other devices, such as a mobile device or other wireless device.

The video I/O device unit 606 may include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video. Additionally or alternatively, the video I/O device may be configured to submit a request to display a visual alert. For example, a visual alert may indicate that the camera is recording, that the camera is out of storage space, etc.

The audio I/O device unit 607 may include a speaker, transducer, and/or a microphone to facilitate voice-enabled functions, such as voice recognition, voice replication, digital recording, and/or telephony functions. The other I/O devices 608 may include a storage device (e.g., a hard drive, a flash memory device), universal serial bus (USB) port(s), serial port(s), a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. The other I/O device units 608 may further include certain sensors coupled to the interconnect 610 via a sensor hub (not shown), while other devices such a button, keyboard, or biometric sensor may be controlled by an embedded controller (not shown), dependent upon the specific configuration or design of the device 600.

To provide for persistent storage of information such as data, applications, one or more operating systems and so forth, a mass storage (not shown) may also couple to the one or more processors 601. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to the one or more processors 601, e.g., via a serial peripheral interface (SPI). This flash device may provide for non-volatile storage of system software, including a basic input/output software (BIOS) as well as other firmware of the system.

The device 600 may be coupled to a network cloud, and the network may be coupled to other electronic devices. For example, the device 600 may communicate with a cloud server over the wireless transceiver(s) 605.

Note that while device 600 is illustrated with various components, it is not intended to represent any particular architecture or manner of interconnecting the components; as such details are not germane to embodiments of the present disclosure. It will also be appreciated that a device having fewer components or perhaps more components may also be used with embodiments of the present disclosure.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, or some other hardware) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the embodiments and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An apparatus, comprising:
a protective shell to protect a head of a wearer of the apparatus, the protective shell including a void of material positioned to be proximate a face of the wearer of the apparatus when wearing the apparatus;
a visual interface device located proximate a border of the protective shell and the void of material; and
a controller to provide display signals to the visual interface device.

2. The apparatus of claim 1, further comprising a storage device storing a static sequence of visual patterns that uniquely identify one of a specific event or notification.

3. The apparatus of claim 2, wherein the static sequence of visual patterns include at least one of a series of colors, patterns, or pulsations.

4. The apparatus of claim 1, further comprising a communication device to communicatively couple the controller with a mobile device or wireless device.

5. The apparatus of claim 4, wherein the controller is configured to provide signals to the visual interface device to dynamically display a sequence of visual patterns associated with a communication received from the mobile device or the wireless device.

6. The apparatus of claim 1, wherein the visual interface device includes a first display component at a top of the void of material and a second display component at a bottom of the void of material.

7. The apparatus of claim 1, wherein the visual interface device includes a plurality of light emitting elements in a group, the plurality of light emitting elements configured such that, based on the display signals, a subset of the plurality of light emitting elements emit light while a remainder of the plurality of light emitting elements do not emit light.

8. The apparatus of claim 1, further comprising a first sensor communicatively coupled to the controller, and wherein the controller provides the display signals based on a signal from the first sensor to the controller.

9. The apparatus of claim 8, further comprising a second sensor communicatively coupled to the controller, and wherein the display signals provide a first pattern based on the signal from the first sensor and the display signals provide a second pattern based on a signal from the second sensor.

10. The apparatus of claim 1, further comprising an electronic storage in communication with the controller, the electronic storage storing a plurality of predefined alerts and an associated pattern of display signals unique among the plurality of predefined alerts.

11. The apparatus of claim 1, wherein the visual interface device is positioned on a visor of the apparatus.

12. The apparatus of claim 1, wherein the visual interface device is positioned on a chin guard of the apparatus.

13. An apparatus, comprising:
a covering to cover eyes of a wearer of the apparatus;
a visual interface device including a plurality of light emitting elements in a group, the visual interface device located proximate a border of the covering; and
a controller to provide display signals to the visual interface device.

14. The apparatus of claim 13, further comprising a shell to protect a head of a wearer of the apparatus.

15. A method, comprising:
receiving, at a controller on a wearable apparatus, a request to display a visual alert on a visual interface device of the wearable apparatus, the visual interface device located at one of a chin guard or a visor of the wearable apparatus; and
displaying the visual alert on the visual interface device.

16. The method of claim 15, further comprising:
determining whether the visual alert is associated with a predefined pattern or a dynamic pattern; and
based on the visual alert being associated with the predefined pattern, the controller generating signals to the visual interface device to display the predefined pattern as the visual alert for a set duration.

17. The method of claim 15, further comprising:
determining whether the visual alert is associated with a predefined pattern or a dynamic pattern; and
based on the visual alert being associated with the dynamic pattern:
parsing a received pattern definition; and
generating, by the controller and based on the parsed pattern definition, signals to the visual interface device to display the dynamic pattern as the visual alert for a duration specified by the parsed pattern definition.

18. The method of claim 17, wherein parsing a received pattern definition includes extracting a pattern, a color, and the duration.

19. The method of claim 15, wherein receiving a request to display a visual alert includes receiving a trigger from one of a plurality of sensors in communication with the controller.

20. The method of claim 15, wherein receiving a request to display a visual alert includes receiving a wireless signal from a mobile device or a wireless device communicatively coupled to the controller.
